(19) United States
(12) Patent Application Publication
(10) Pub. No.: US 2012/0227223 A1
(43) Pub. Date: Sep. 13, 2012

(54) STRAP TENSIONING SYSTEM

(76) Inventor: Howard T. Knox, Independence, KY (US)

(21) Appl. No.: 13/413,750

(22) Filed: Mar. 7, 2012

Related U.S. Application Data
(60) Provisional application No. 61/449,775, filed on Mar. 7, 2011.

(51) Int. Cl. B60P 7/06

(52) U.S. Cl. 24/68 CD

(57) ABSTRACT

A strap tensioning system having a frame and a core shaft on the frame. The system further has first and second separate lengths of flexible strap extending generally oppositely away from the frame, a drive shaft, and a gear assembly with a worm and a worm gear that are driven by the drive shaft. The drive shaft is operable to drive the gear assembly to thereby cause the first length of flexible strap to be wrapped around the core shaft to thereby vary a combined effective length of the first and second lengths of flexible strap.

### CROSS-REFERENCE TO RELATED APPLICATIONS

This application is a non-provisional of U.S. Ser. No. 61/449,775, filed Mar. 7, 2011.

### BACKGROUND OF THE INVENTION

1. Field of the Invention

This invention relates to tensioners for flexible straps as used to secure cargo, as on vehicles, and the like.

2. Background Art

Flexible straps are used in a wide range of environments to confine and hold down objects, either individually or in a grouped configuration. In one exemplary environment, articles placed on pallets are shipped in vehicles through placement either on a flat bed or on an elevated tier formed using laterally spanning load beams, as disclosed n U.S. Pat. No. 6,364,583, incorporated herein by reference. Straps are strategically spanned across the articles and/or pallets and tensioned to thereby prevent shifting of the pallets while the vehicle is moving.

Different mechanisms have been devised to tension straps through either a manual actuator or utilizing a powered input.

In one form, as depicted in U.S. Pat. No. 7,618,021, incorporated herein by reference, a ratchet mechanism is used to progressively tension a strap. While the basic ratcheting mechanism has been used effectively for decades, it has a number of drawbacks.

First of all, ratchet mechanisms generally require a repetitive, back-and-forth movement of an actuator. Access to, and available space for operation of, the actuator may vary from one operation to the next, depending upon the type of vehicle, the nature of the load, and the available space that is unoccupied by the cargo to be transported. Even if the actuator is accessible and operable, often its situation is such that its operation may be awkward, or potentially even uncomfortable, for a user thereof.

This and other types of actuators may also be prone to reconfiguring when an associated strap is in a tensioned state, whereby the strap might be loosened, or in a worst case, altogether released. This problem might be encountered with an actuator incorporating cooperating gears typically found on a conventional winch. In these designs, a separate locking assembly must be provided to releasably lock the gears so that they cannot be reversely turned in a manner to release tension upon the strap.

One alternative design utilizes a powered actuator. These designs also contend with the problem of accidental belt slackening. One example of a powered actuator is shown in U.S. Pat. No. 7,216,849.

Further, these designs typically are quite large and often become relatively complicated and expensive. Thus, their usage may be limited by space requirements. Further, it may be impractical, from a financial standpoint, to incorporate a necessary number of these devices to secure all of the straps on a particular vehicle.

Several industries continue to seek out alternative strap tensioner designs that are compact, effective in operation, and practical to employ, in terms of their operability and cost.

### SUMMARY OF THE INVENTION

In one form, the invention is directed to a strap tensioning system including: a frame; a core shaft on the frame; first and second separate lengths of flexible strap extending generally oppositely away from the frame; a drive shaft; and a gear assembly made up of a worm and a worm gear that are driven by the drive shaft. The drive shaft is operable to drive the gear assembly to thereby cause the first length of flexible strap to be wrapped around the core shaft to thereby: a) vary a combined effective length of the first and second lengths of flexible strap; and b) produce tension on the first and second lengths of strap.

In one form, the frame has first and second side walls between which a strap storage space is defined. The frame has a top and bottom and spaced first and second ends.

In one form, the core shaft extends between the first and second side walls and moves guidingly around a first axis.

In one form, the drive shaft is operable by being moved around a second axis and the worm is driven by the drive shaft around the second axis.

In one form, the frame has a flat mounting surface to be engaged with a support for the strap tensioning system. The flat mounting surface resides in a first plane and the second axis is substantially orthogonal to the first plane.

In one form, an anchor post is provided on the frame and connected to an end of the second length of flexible strap.

In one form, the anchor post has a length with a third axis and the second axis resides between the first and third axes.

In one form, the strap tensioning system further includes a crank handle for operating the drive shaft. The crank handle has a body with a length projecting away from the second axis to a free end. The free end traces an annular path with a diameter as the crank handle is moved to operate the drive shaft and the majority of the diameter of the annular path resides between the first and second frame ends.

In one form, the second axis resides approximately mid-way between the first and second frame ends.

In one form, the diameter of the annular path is approximately equal to a distance between the first and second frame ends.

In one form, the crank handle further includes a graspable component adjacent to the crank handle free end that can be grasped by a user to manually move the crank handle.

In one form, the graspable component is movable relative to the crank handle body between operating and stored positions and the graspable component has a projection along the second axis that is greater with the graspable handle in the operating position than with the graspable handle in the stored position.

In one form, the drive shaft has an axis. One of the side walls is formed from a flat piece and the flat piece is bent to define a tab for supporting the drive shaft and through which the drive shaft axis extends.

In one form, there is a first web that connects between the first and second side walls and the first web and first and second side walls are made from a single piece of formed flat metal stock.

In one form, the single piece of flat metal stock is bent to define spaced tabs upon which the drive shaft is supported.

In one form, the strap tensioning system further includes a lock assembly having on and off states and at least one lock component. With the lock assembly in the on state, the at least one lock component interacts with the worm gear to block movement of the worm gear.

In one form, the strap tensioning system further includes a cup-shaped cover component that cooperates with one of the side walls to define a chamber for at least a part of the gear assembly.

In one form, there is a second web that connects between the first and second side walls and is defined by the single piece of formed flat metal stock.

In one form, the gear assembly is provided on one of the side walls and the other of the side walls has a flat shape residing in a plane and the other of the side walls has a rib bent out of the plane between the first and second webs.

In one form, the strap tensioning system is provided in combination with a powered drive for turning the drive shaft.

### BRIEF DESCRIPTION OF THE DRAWINGS

FIG. 1 is a side elevation view of a strap tensioner, according to the present invention;

FIG. 2 is a plan view of the strap tensioner in FIG. 1 with cooperating strap lengths that, together with the strap tensioner, define a strap tensioning system;

FIG. 3 is an elevation view of the strap tensioner from the side opposite that in FIG. 1;

FIG. 4 is a view as in FIG. 3 wherein a portion of the strap tensioner has been broken away to expose working components thereon;

FIG. 5 is a view as in FIG. 3 with a cover component removed;

FIG. 6 is an end elevation view of a frame on the strap tensioner in FIGS. 1-5;

FIG. 7 is a plan view of the frame in FIG. 6;

FIG. 8 is an enlarged, elevation view of a drive shaft on the strap tensioner in FIGS. 1-7;

FIG. 9 is an enlarged, elevation view of a worm that is part of a gear assembly that transmits a turning force of the drive shaft into a turning force upon a core shaft around which a strap is wound;

FIG. 10 is a fragmentary, perspective view of a strap tensioning system with a modified form of strap tensioner, according to the invention;

FIG. 11 is a fragmentary, elevation view of the strap tensioner from the side opposite that of FIG. 10;

FIG. 12 is a view of the components in FIG. 10 from a different perspective and with a cap separated from a frame on the strap tensioner;

FIG. 13 is a view as in FIG. 10 with a graspable component repositioned from an operative position, as in FIG. 10, to a stored position; and

FIG. 14 is a schematic representation of a modified form of strap tensioning system, according to the present invention.

### DETAILED DESCRIPTION OF THE PREFERRED EMBODIMENT

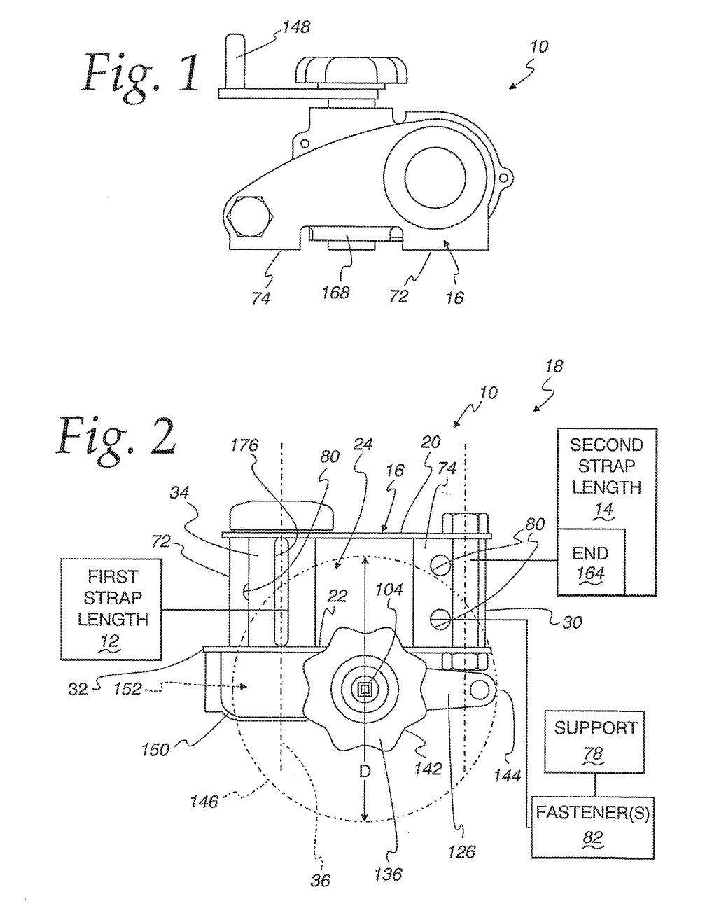

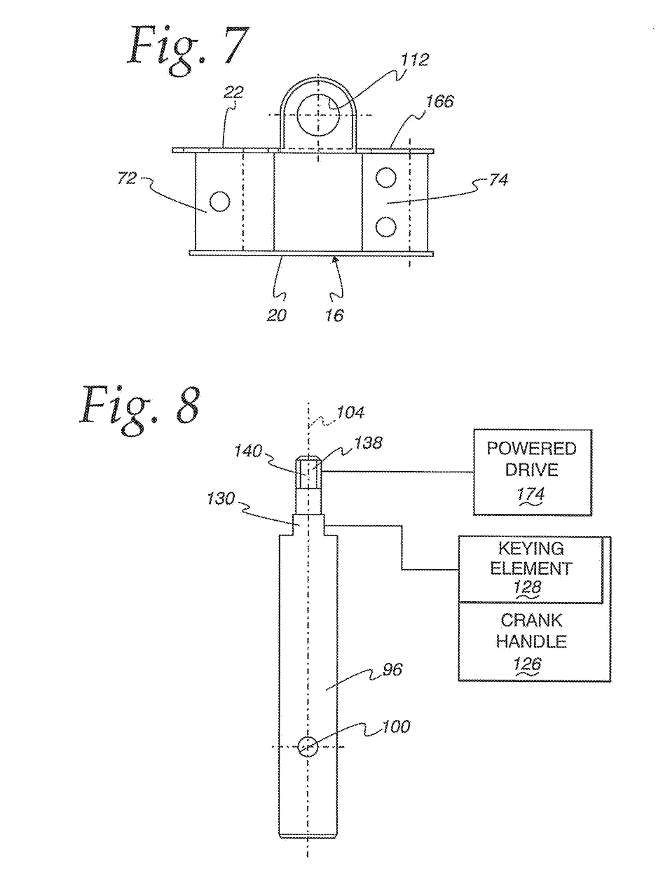

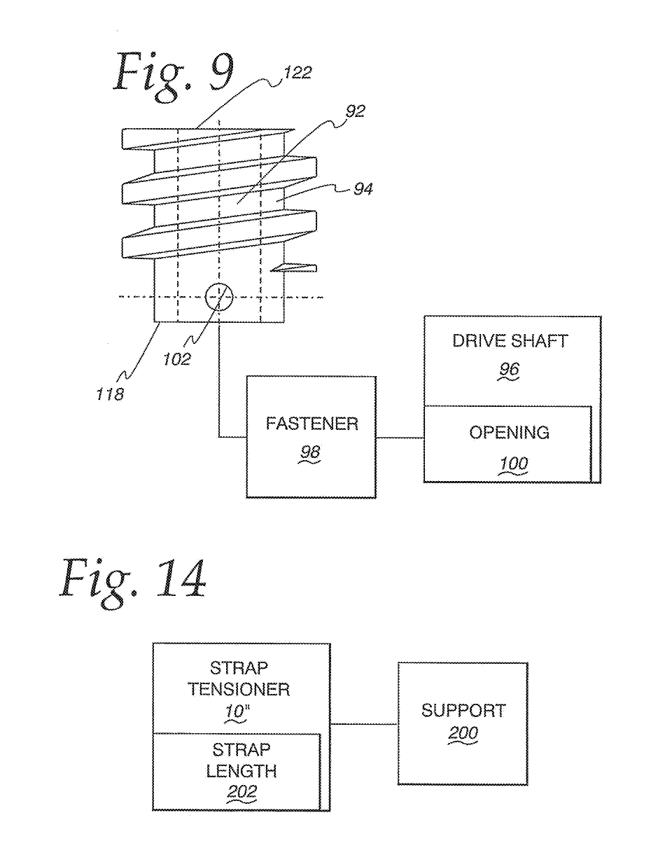

One form of strap tensioner, according to the present invention, is shown in FIGS. 1-9 at 10. The strap tensioner 10, as shown in FIG. 2, is operatively associated with first and second strap lengths 12, 14 that project oppositely from a frame 16 on the strap tensioner 10. The strap tensioner 10 and strap lengths 12, 14 together define a strap tensioning system 18. The strap lengths 12, 14 may be made from well known flexible materials that are preferably flat. The width of the strap material is not critical, nor is it critical that both strap lengths 12, 14 have the same construction. In one exemplary form, the strap tensioner 10 can be made with a compact overall design to accommodate a typical two-inch wide web strap.

As will be explained in greater detail below, the strap tensioner 10 can be operated to vary, by either extending or shortening, a combined effective length of the first and second strap lengths 12, 14. By shortening the effective length thereof, a tension can be produced on both the first and second strap lengths 12, 14.

The strap lengths 12, 14 may be part of the same continuous strap. Alternatively, the strap lengths 12, 14 may have ends spaced from the strap tensioner 10 that are fixed.

The frame 16 on the strap tensioner 10 has first and second side walls 20, 22, respectively, between which a strap storage space 24 is defined. The frame has a top 26, a bottom 26, and first and second spaced ends 30, 32, respectively.

A core shaft 34 extends between and through the side walls 20, 22 and is mounted for movement relative to the frame 16 about a first axis 36. Bushings 38, 40 are provided respectively in openings 42, 44 on the side walls 20, 22, to guide smooth turning of the core shaft 34 relative to the frame 16.

The core shaft end 46 supports a worm gear 48. A spacer 50 resides between the bushing 40 and worm gear 48. A retaining clip 52 is seated in an annular undercut 54 on the core shaft 34 and axially captures a washer 56 against the worm gear 48.

The opposite core shaft end 58 receives a retaining clip 60 that is assembled in the same manner as the retaining clip 52. A bearing 62 is captured between the retaining clip 60 and the bushing 38.

With this arrangement, the core shaft 34 is confined against axial movement relative to the frame 16 and guided smoothly for turning relative thereto around the axis 36.

A cap 64 is mounted at the shaft end 58 and has a cylindrical seating portion 66 that frictionally seats within the core shaft 34. A cup-shaped wall 68 on the cap 64 defines in conjunction with the side wall 20 a chamber 70 within, which the retaining clip 60 and bearing 62 reside.

The walls 20, 22 are joined by first and second webs 72, 74 at the bottom of the frame 16. The bottoms of the webs 72, 74 together define a flat mounting surface 76 that resides within a plane P. The mounting surface 76 can be engaged with a support 78 for the strap tensioning system 18. The support 78 may be any sturdy structure that will stably support the tensioning system 18.

Openings 80 are provided through the webs 72, 74 to accept one or more fasteners 82 which can be directed therethrough and into the support 78. The nature of the fasteners 82 is not critical to the present invention and is dictated by the particular application.

The worm gear 48 has a spur gear configuration. The worm gear 48 has diametrically opposite, radially inwardly projecting tabs 86 that are slid axially into slots 88 on the core shaft end 46 produced by bifurcation thereof. Through this arrangement, the worm gear 48 is positively keyed against turning relative to the core shaft about the axis 36.

The worm gear 48 has teeth 90 that move within a spiral groove 92 formed on a worm 94. The worm 94 is mounted to a drive shaft 96. A fastener 98 is directed into aligned openings 100, 102, respectively on the drive shaft 96 and the worm 94. The drive shaft 96 and worm 94 move together as one piece around a second axis 104. The worm 94 and worm gear 48 together make up a gear assembly at 106. Turning of the worm 94 and drive shaft 96 about the axis 104 causes the core shaft 34 to turn around its axis 36.

The drive shaft 96 and worm 94 are supported on the frame 16 by upper and lower tabs 108, 110, respectively. The tabs 108, 110 have aligned throughbores 112, 114, respectively. The bores 112, 114 are concentric with the axis 104.

The drive shaft 96 extends through the tabs 108, 110 and the worm 94 that is captive therebetween. Spacers 116 are provided between the bottom worm end 118 and the tab 110.

Separate spacers 120 reside between the upper worm end 122 and upper tab 108. Spring washers 124 are located between the separate spacers 120 to permit a modicum of axial shifting of the worm 94 so as to thereby prevent binding with the worm gear 48.

A fiat crank handle 126 has a keying element 128 that is press fit to a keying element 130 on the drive shaft 96 so that a body 132 of the crank handle projects away from the axis 104 to provide a lever arm through which the drive shaft 96 and associated worm 94 can be driven around the axis 104.

A spacer 134 resides between the crank handle 126 and upper tab 108. A retaining cap 136 can be directed over the end 138 of the drive shaft 96 and may be press fit or screw threaded to an end fitting 140 to captively maintain the crank handle 126 in its operative position against the spacer 34 and underlying tab 108. The retaining cap 136 has a knurled, or wave-patterned, perimeter 142 to facilitate grasping and turning thereof. The retaining cap 136 can be grasped and turned to secure the retaining cap 136 and/or to assist turning of the drive shaft 96, as hereinafter explained.

The crank handle body 132 projects away from the axis 104 to a free end 144. As the drive shaft 96 is turned around the axis 104, the free end 144 traces an annular path, indicated by the dotted line 146. The annular path has a diameter D. The majority, and as seen in FIG. 2 substantially the entirety, of the diameter D resides between the first and second frame ends 30, 32.

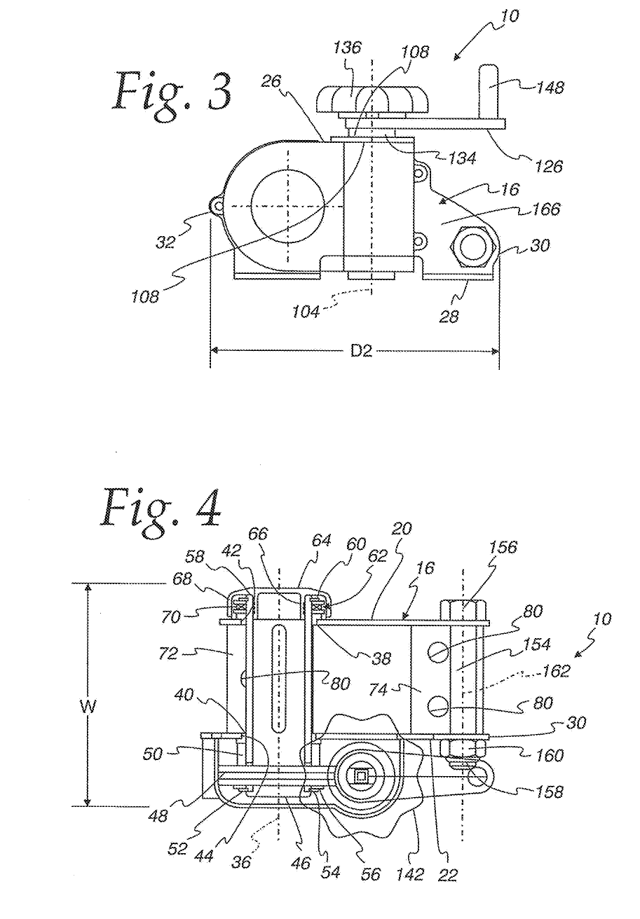

In the embodiment depicted, the axis 104 resides approximately mid-way between the first and second frame ends 30, 32. Further, as seen in FIGS. 2 and 3, the diameter D of the annular path is approximately equal to a distance D2 between the first and second frame ends 30, 32.

A graspable component, in the form of a post 148, projects vertically from the crank handle 126 adjacent to the free end 144. The post 148 can be grasped, as between a user's finger(s) and thumb, to facilitate turning of the crank handle 126 about the axis 104. As noted above, the turning force can be assisted by a torque applied to the retaining cap 136.

A cup-shaped cover component 150 can be releasably connected to the side wall 22 and cooperates therewith to define a chamber 152 for at least a part, and in this case the entirety, of the gear assembly 106.

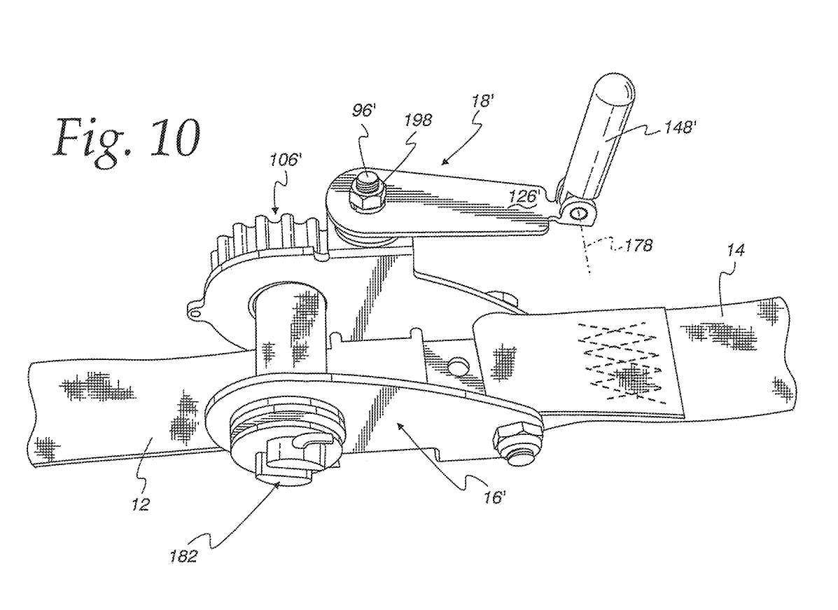

An anchor post 154 extends between the side walls 20, 22 adjacent to the frame end 30. In this embodiment, the anchor post 154 is in the form of a bolt with a head 156 at one end and a shank with a threaded end 158 opposite the head end that threadably engages a nut 160. The anchor post 154 has a length with a third axis 162. An end 164 of the second strap length 14 connects to the anchor post 154, as by being wrapped around the anchor post to be doubled against itself and secured, as shown for the strap length 14 in FIG. 10 on a separate embodiment of strap tensioning system 18′.

The above described design allows the frame 16 to be made from a single piece of flat stock at 166, that may be formable metal. The single piece 166 may be used to define all or any different ones of the side walls 20, 22, webs 72, 74, and tabs 108, 110. Any two or more of these components could be formed from the single flat piece 166. If less than all of the components are made from a single piece, they might be combined by welding and/or the use of fasteners by techniques well known to those skilled in the art.

By turning the crank handle 126, the core shaft 34 is turned which causes the first length of flexible strap 12 to be wrapped around the core shaft 34 to thereby shorten the combined effective length of the first and second lengths 12, 14 of the flexible strap. As this occurs, tension is produced on both the first and second strap lengths 12, 14.

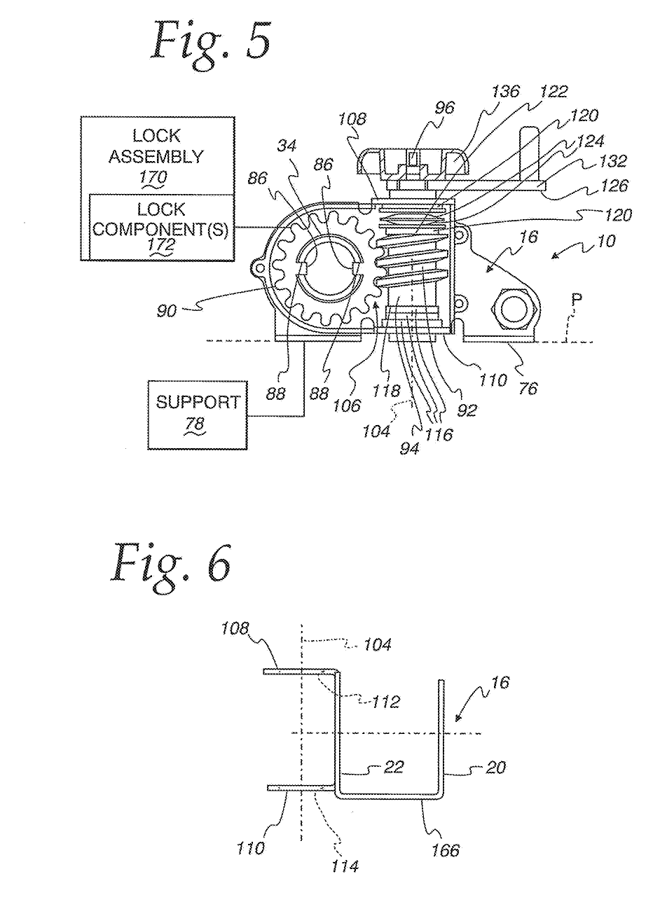

The depicted arrangement of components allows for a very compact overall design for the strap tensioner 10. In this embodiment, the second axis 104 is oriented substantially orthogonally to the plane P, as seen in FIG. 5. While a substantially perpendicular relationship is preferred, a slight angle to perpendicular, varying by 10°-15°, may be permitted without interfering with operation.

The axis 104 resides between the axes 36, 162. Accordingly, the components can be compactly placed within the dimension D2 between the ends 30, 32 of the frame 16.

The strap tensioner width W can be controlled so that it is not substantially greater than the width of the strap that will be accommodated by the frame 16. As noted, the invention can be used conveniently with a two-inch strap width. The crank handle 126 moves in a path that overlies the frame 16 so that the space requirements for operation are controlled, thereby allowing the strap tensioning system 18 to be used in a relatively tight space.

In this embodiment, an elongate rib 168 is bent out of the plane of the wall 20 between the webs 72, 74 to provide clearance and for purposes of reinforcing the wall 20 against bending.

Another optional feature is the incorporation of a lock assembly 170 on the frame 16, as seen in FIG. 5. The lock assembly 170 has at least one lock component 172. With the lock assembly in an on state, the at least one lock component 172 interacts with the worm gear 48 to block movement around the axis 36 at least in a direction that would tend to loosen tensioned strap lengths. This increases both the braking strength and adds security so that the worm gear 48 will not back off, as under the influence of vibrational forces with a light tension on the strap lengths.

As an alternative to using the crank handle 126, a powered drive, as shown at 174 in FIG. 8, may be keyed to the drive shaft 96. The system may be designed to accommodate only the powered drive 174. Alternatively, the system may be designed to be selectively manually or power driven. In that case, the retaining cap 136 can be removed to allow the power drive 174 to engage the end fitting 140 for turning of the drive shaft 96. The drive may he a conventionally available drive, such as a 120 v drill, a pneumatic drive, etc. The drive shaft 96 may alternatively be driven by a releasable tool, such as a ratchet wrench.

By reason of using the worm arrangement, tension produced on the strap will not induce a force upon the drive shaft 96 tending to turn the worm gear 48. In fact, tension generated by the strap lengths 12, 14 tends to wedge the worm gear teeth 90 within the worm groove 92, thereby minimizing the likelihood of back-off of the core shaft 34 with the strap lengths 12, 14 under tension.

The gearing can be designed by one skilled in the art so that an adequate tension can be applied to a strap without excessive torque application by a user.

Connection of the first strap length 12 to the core shaft 34 is facilitated by providing a through slot 176 therein.

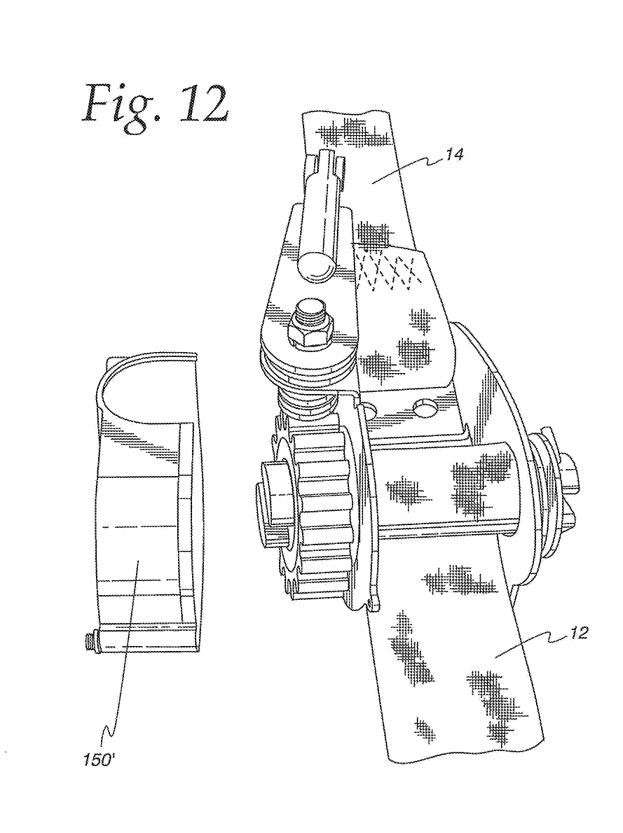

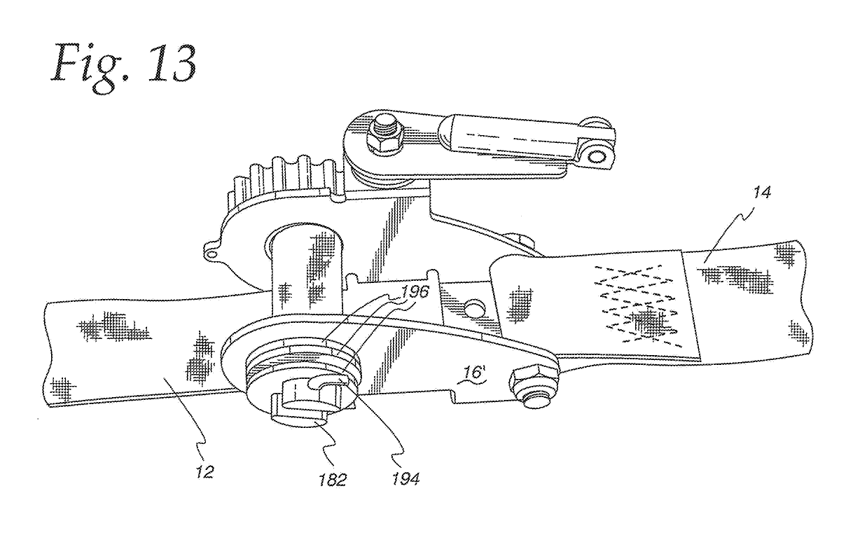

In FIGS. 10-13, a modified form of strap tensioning system is shown at 18′. The strap tensioning system 18′ cooperates with the first and second strap lengths 12, 14, in substantially the same manner as the strap tensioning system 18 does. Only differences between the strap tensioning systems 18, 18′ will be described below, with elements on the strap tensioning system 18′ identified with the same reference numerals as used to identify corresponding elements on the strap tensioning system 18, but with the addition of a “′” designation.

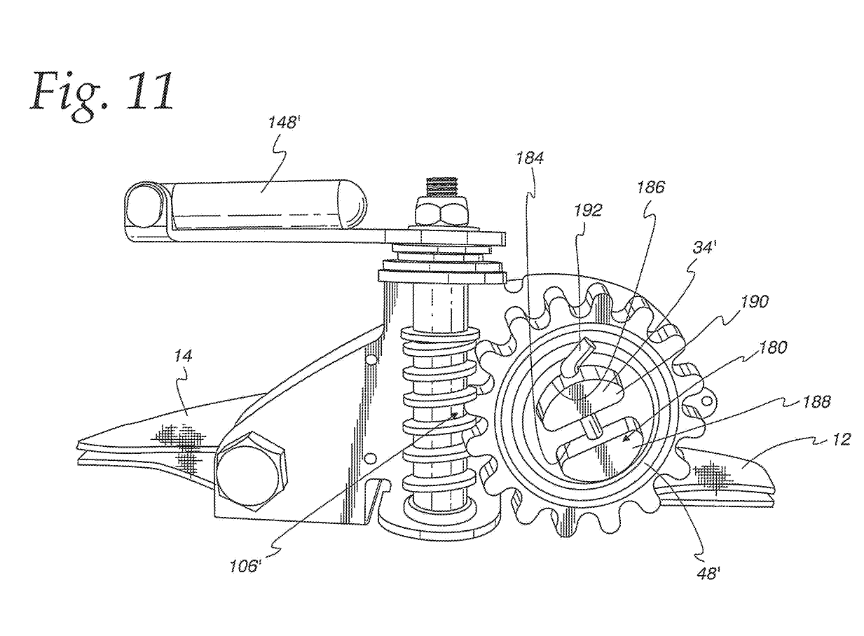

As can be seen by comparing FIGS. 2 and 10, the gear assembly 106′ and crank handle 126′ operate the same as the gear assembly 106 and crank handle 126 but are provided on the opposite side of the frame 16′.

Whereas the graspable component/post 148 is fixed on the crank handle 126, the corresponding graspable component/post 148′ is pivotable about an axis 178 relative to the crank handle 126′ for movement between an operating position, as shown in FIG. 10, and a stored position, as shown in FIG. 11.

The core shaft 34′ has bifurcated opposite ends 180, 182 and is split therebetween to obviate the need for the aforementioned slot 176 to facilitate fixing of the end of the strap length 12. The worm gear 48′ has discrete openings 184, 186 through which complementarily-shaped portions 188, 190 of the core shaft 34′, respectively, project. A bar 192 passes through the exposed shaft portions 188, 190 and is bent at its ends so that it will not separate therefrom. The bar 192 blocks the worm gear 48′ against separation from the core shaft 34′.

The shaft end 182 has a similar configuration and cooperates with a bar 194 to block axial shifting of the core shaft 34′. Spacers 196 surround the core shaft 34′ and reside between the bar 194 and frame 16′.

A cover component 150′ cooperates with the frame 16′ to cover the gear assembly 106′.

In this embodiment, a nut 198 secures the crank handle 126′ to the drive shaft 96′.

While the strap fastener system has been described with respect to separate strap lengths 12, 14, a strap tensioner, according to the invention, as shown at 10″ in FIG. 14, can be mounted to a support 200 and used to tension a single strap length 202.

The foregoing disclosure of specific embodiments is intended to be illustrative of the broad concepts comprehended by the invention.

1. A strap tensioning system comprising:
a frame;
a core shaft on the frame;
first and second separate lengths of flexible strap extending generally oppositely away from the frame;
a drive shaft; and
a gear assembly comprising a worm and a worm gear that are driven by the drive shaft,
the drive shaft operable to drive the gear assembly to thereby cause the first length of flexible strap to be wrapped around the core shaft to thereby: a) vary a combined effective length of the first and second lengths of flexible strap; and b) produce tension on the first and second lengths of strap.

2. The strap tensioning system according to claim 1 wherein the frames comprises first and second side walls between which a strap storage space is defined, the frame having a top and bottom and spaced first and second ends.

3. The strap tensioning system according to claim 2 wherein the core shaft extends between the first and second side walls and moves guidingly around a first axis.

4. The strap tensioning system according to claim 3 wherein the drive shaft is operable by being moved around a second axis and the worm is driven by the drive shaft around the second axis.

5. The strap tensioning system according to claim 4 wherein the frame defines a flat mounting surface to be engaged with a support for the strap tensioning system, the flat mounting surface residing in a first plane and the second axis is substantially orthogonal to the first plane.

6. The strap tensioning system according to claim 4 wherein an anchor post is provided on the frame and connected to an end of the second length of flexible strap.

7. The strap tensioning system according to claim 6 wherein the anchor post has a length with a third axis and the second axis resides between the first and third axes.

8. The strap tensioning system according to claim 5 further comprising a crank handle for operating the drive shaft, the crank handle having a body with a length projecting away from the second axis to a free end, the free end tracing an annular path with a diameter as the crank handle is moved to operate the drive shaft and the majority of the diameter of the annular path resides between the first and second frame ends.

9. The strap tensioning system according to claim 8 wherein the second axis resides approximately mid-way between the first and second frame ends.

10. The strap tensioning system according to claim 9 wherein the diameter of the annular path is approximately equal to a distance between the first and second frame ends.

11. The strap tensioning system according to claim 8 wherein the crank handle further comprises a graspable component adjacent to the crank handle free end that can be grasped by a user to manually move the crank handle.

12. The strap tensioning system according to claim 11 wherein the graspable component is movable relative to the crank handle body between operating and stored positions and the graspable component has a projection along the second axis that is greater with the graspable handle in the operating position than with the graspable handle in the stored position.

13. The strap tensioning system according to claim 2 wherein the drive shaft has an axis, one of the side walls is formed from a flat piece and the flat piece is bent to define a tab for supporting the drive shaft and through which the drive shaft axis extends.

14. The strap tensioning system according to claim 2 wherein there is a first web that connects between the first and second side walls and the first web and first and second side walls are made from a single piece of formed flat metal stock.

15. The strap tensioning system according to claim 14 wherein the single piece of flat metal stock is bent to define spaced tabs upon which the drive shaft is supported.

16. The strap tensioning system according to claim 1 further comprising a lock assembly having on and off states and at least one lock component and with the lock assembly in the on state the at least one lock component interacts with the worm gear to block movement of the worm gear.

17. The strap tensioning system according to claim 2 further comprising a cup-shaped cover component that cooperates with one of the side walls to define a chamber for at least a part of the gear assembly.

18. The strap tensioning system according to claim 14 wherein there is a second web that connects between the first and second side walls and is defined by the single piece of formed flat metal stock.

19. The strap tensioning system according to claim 18 wherein the gear assembly is provided on one of the side walls and the other of the side walls has a flat shape residing in a plane and the other of the side walls has a rib bent out of the plane between the first and second webs.

20. The strap tensioning system according to claim 1 in combination with a powered drive for turning the drive shaft.
